(19) United States
(12) Patent Application Publication
(10) Pub. No.: US 2009/0125636 A1
(43) Pub. Date: May 14, 2009

(54) Payload allocation methods for scalable multimedia servers

(76) Inventors: Qiong Li, Tappan, NY (US); Linfeng Guo, Tenafly, NJ (US); Michael David Vernick, Ocean, NJ (US); Mark Sydorenko, New York, NY (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/985,054

(22) Filed: Nov. 13, 2007

(51) Int. Cl. G06F 15/16

(52) U.S. Cl. 709/231

(57) ABSTRACT

The dynamic streaming of multimedia data between a data server and one or more clients is disclosed. Dynamic streaming enables the rapid and accurate characterization of the end-to-end path conditions in a server-client streaming session, as well as the rapid and intelligent response to those conditions in terms of source compression prior to data packetization. The most significant bits of an original bit stream can be adaptively and immediately selected in response to network conditions. The adaptive selection process is informed by feedback from the client receiver indicative of a time-to-transit the network from server to client. A control protocol and server architecture, including file format, data structure, data processing procedures, cache control mechanisms, and adaptation algorithms useful in implementing dynamic streaming are also disclosed.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

Streaming multimedia content, such as audio or video, over an unreliable packet-switched network, while achieving acceptable quality to an end-user, can be a hard problem. Before streaming multimedia content over a packet-switched network, such as the Internet, content is normally compressed from its original source into a compressed bitstream to reduce the amount of data to be sent over the network. Once the bitstream arrives at a playback device such as a computer, or mobile phone, the compressed bitstream is uncompressed into a form that can be played back by the playback device and viewed by the user if it includes video or listened to by the user if the bitstream includes audio. These bitstreams may be streamed over packet-switched networks utilizing the network protocols such as the Transaction Control Protocol/Internet Protocol (TCP/IP) or User Datagram Protocol/Internet Protocol (UDP/IP).

To transmit compressed bitstreams over a packet-switched network from a multimedia content server to a playback device, the bitstreams are divided into small units which are then encapsulated into data packets as packet payloads, a process referred to as packetization. An underlying network protocol, such as TCP or UDP, is then responsible for transmitting the data packet from source to destination over the network.

Packetization of bitstreams during streaming can be based upon static information (metadata) that is created using pre-established criteria when the original content is compressed. A server will then construct packets in real-time on the basis of the pre-stored metadata. For example, in the MPEG-4 standard, the metadata is called ‘hint tracks.’ The hint tracks are stored along with the compressed data and contain general instructions for streaming servers as how to form packet streams based on the MPEG-4 content.

When packet-switched networks become congested and cannot sustain a consistent transmission bit rate, the server may aggressively or passively skip packets that should be sent with what are judged to be semantically less important media data. The skipping is performed at the granularity of the packet. Since each packet payload is predetermined, the adaptability and flexibility of such systems is limited, particularly when applied to media streaming applications over highly variable bit-rate networks such as wireless networks. In the latter case, the overall bit rate is relatively low and network throughput, or in other words the available bandwidth, is susceptible to frequent and rapid changes.

In order to avoid the loss of packet data upon network congestion or other bandwidth restrictions, one currently known approach compresses a source data file into multiple versions, each version having a different bit-rate. The higher the bit-rate, the better the quality, and the more closely the version resembles the original recording. The system then assesses dynamic network properties, such as the available bandwidth between the server and the playback device, and sends the compressed version with the highest bit-rate that can be accommodated by the current network conditions. If the network conditions change, the server can change the version that is sent based on whether the available bandwidth has increased or decreased. One problem with this approach is that there can be a noticeable change in quality by the user when the switching occurs. In addition, storage requirements increase because several versions of the original recording must be stored and maintained.

More recently, systems have achieved better quality of service of multimedia content by employing scalable content coding. In a scalable coding scheme, an original recording is compressed into a bitstream that is comprised of multiple layers. Higher layers depend on lower layers and add more information to the transmitted bitstream, thus increasing the quality of the final output. The base layer of the bitstream is the minimum bitstream that needs to be transmitted over the network for acceptable output. A scalable content server transmits as many layers as possible constrained by network conditions, the more layers sent and received by the playback device, the higher the quality.

In such a scalable content system, a bitstream is broken into frames (from the original audio sample or video frame) and then each frame is broken into layers. The content server creates a data packet to be transmitted from the server to playback device by starting at the base layer and adding layers to the packet until the system determines, using network conditions, that no more layers should be transmitted. In this case, no more than one frame of data is added to a single data packet. A problem arises however, in that packetization of the bitstream is not optimized.

A system and method is needed for the application level packetization of scalable multimedia content to be sent efficiently over a packet-switched network. The packetization of content should be dynamically adaptable, not only adapting based upon low-level network conditions determined by the server, but also based on other application level criteria, such as the failure rate of frames to reach the intended playback device in time to be played out.

The quality of the playback at the user's playback device should also be taken into account. In a scalable system, the playback quality is proportional to the number of layers being decoded. When adapting to network conditions, the dynamic packetization strategy should try to gracefully increase or decrease the quality of the playback, rather than creating abrupt changes.

### BRIEF SUMMARY OF THE INVENTION

The presently disclosed invention pertains to the dynamic streaming of scalable multimedia content between a content server and one or more playback devices or clients. Dynamic streaming is a streaming technique which enables the rapid and accurate characterization of the end-to-end network path conditions and application level conditions (such as the failure rate of packets to be played out in time at the playback device) in a server-client streaming session, as well as the rapid and intelligent response to those conditions in terms of choosing the appropriate data to be transmitted during data packetization.

A system and method will be described that packetizes compressed scalable bitstreams in the face of varying network and application level conditions. Packetization is an adaptive process informed by feedback from the network or playback device indicative of varying performance conditions. As bitstreams are dynamically packetized, packets are sent over a packet-switched network by an underlying network protocol such as TCP or UDP. User defined parameters are included in the adaptation method so that the system can be tuned and tested on different network architectures. The adaptation and packetization algorithms for implementing dynamic streaming will be disclosed.

### BRIEF DESCRIPTION OF THE SEVERAL VIEWS OF THE DRAWINGS

The invention will be more fully understood by reference to the following description in conjunction with the accompanying drawings of which:

FIG. 1 illustrates how a compressed bitstream is broken down into frames and sub-frames based on layers according to the presently disclosed invention;

FIG. 2 illustrates the concept of base layer offset as utilized in the presently disclosed invention;

FIG. 3 illustrates the composition of a packet payload configurable according to the presently disclosed invention;

FIG. 4 is a block diagram of a data server according to the presently disclosed invention; and

FIG. 5 is a block diagram illustrating functional tasks executed in the data server of FIG. 4.

### DETAILED DESCRIPTION OF THE INVENTION

U.S. Pat. No. 6,091,773 discloses a Neural Encoding Model (NEM) which summarizes the manner in which sensory signals are represented in the human brain. The patent also discloses techniques in which the NEM is analyzed in the context of detection theory, the latter providing a mathematical framework for statistically quantifying the detectability of differences in the neural representation arising from differences in sensory input. A method is then described in which the “perceptual distance” between an approximate, reconstructed representation of an audio and/or video signal and the original signal is calculated. The perceptual distance in this context is a direct quantitative measure of the likelihood that a human observer can distinguish the original audio or video signal from the reconstructed approximation. The method can be used to allocate bits in audio and video compression algorithms such that the signal reconstructed from the compressed representation is perceptually similar to the original signal when judged by a human observer.

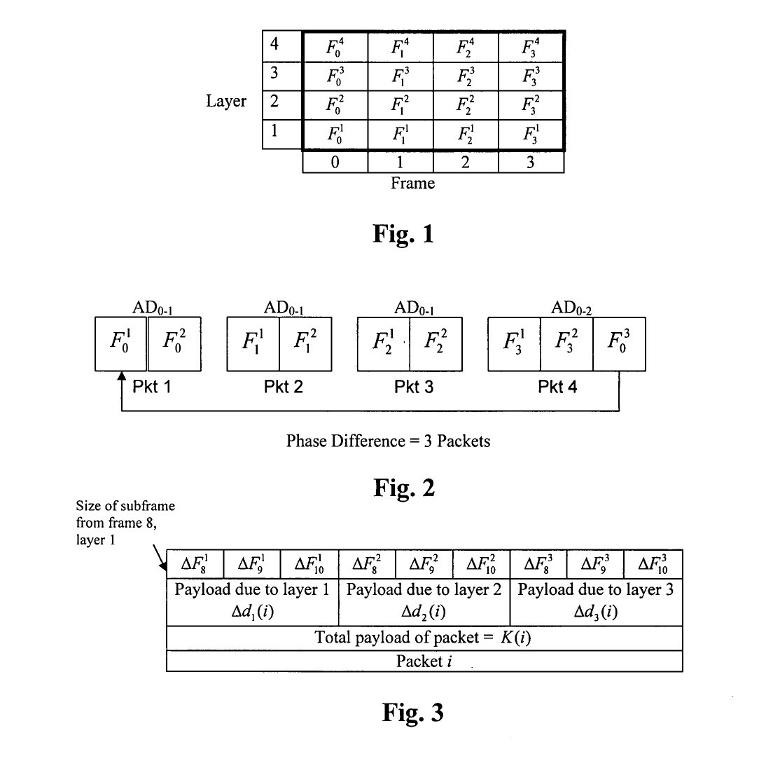

The presently disclosed dynamic streaming technology relies upon a scalable layered coding, like NEM, to optimize the packetization of media data. As shown in FIG. 1, scalable compressed data files are organized into data units, which may also be called coding blocks or “frames.” Frames are independently decodable by the playback device. Scalable data files are also organized into layers. Layers are indexed with an ID from 1 to N. The layer assigned ID equal to 1 is referred to as the base layer. The base layer can be independently decoded by the playback device. Layers with IDs higher than 1 are referred to as enhancement layers. In certain embodiments, enhancement layers are also independently decodable, whereas in other embodiments, for layer L to be decoded, all layers from 1 to L−1 must also be available to the decoder. Thus, each frame can be further divided into smaller units, each referred to as a sub-frame where a sub-frame corresponds to a layer within the frame. As in FIG. 1, a sub-frame is referenced as Fⱼ^{L} where j corresponds to the frame index and L corresponds to the layer. A partially received frame containing sub-frames from layers 1 to L (N being the maximum layer number, where L≦N) will still be decodable.

The packetization strategy consists of deciding which sub-frames should be allocated into successive packets. An optimal packetization strategy may take into account estimates of decreases in network throughput to insure that at least partial frames arrive at the client in time for uninterrupted playback. Optimal strategies may further be constrained to insure the best quality end-user experience under the network conditions.

The context for the presently disclosed invention includes a content server connected to multiple clients, or playback devices, via a packet-switched communications network. Multimedia content files, typically audio, video, or both, are compressed using a scalable encoding algorithm. Specifically, the data comprising the bitstream must be generally scalable by: being constituted of individually decodable frames; each frame being further constituted of layers (or “sub-frames”); and partially received frames being decodable as described above. These requirements are met by bitstreams generated by a variety of audio/video coding methods, including NEM, Fine-Granularity-Scalability (FGS), Data Partition, Wavelet Coding, etc. for video, and NEM, bit-plan coding, etc. for audio.

The underlying network provides a packet-switching data service to multimedia applications. The maximum packet size is explicitly specified and enforced by network interfaces. Transport control over the end-to-end path is enforced such that the Server can only send a packet when the network allows it to do so. The network may explicitly define the proper interval between packets that the application should adhere to, or allows the application to derive the proper interval. For example, such an interval is denoted as Δ(tᵢ), which represents the departure interval between packet i and i+1.

The end-to-end path is bi-directional, and should be able to provide enough average throughput to guarantee the in-time delivery of at least the base layer of the content. As previously indicated, the base layer is regarded as layer 1. In addition, a playback device can send feedback to the Server to indicate a particular state or reflective of information received in conjunction with streaming data, such as the time certain data was transmitted by the Server and the time it was received by the Player. Those familiar in the art will be knowledgeable about the various types of feedback that can be sent from the playback device to the content server. Feedback information can then be used to infer network conditions and used in the dynamic packet allocation algorithms described below.

A time period during which the Server sends data from a particular layer without interruption is defined as the Active Duration (AD) of that layer. If the data for an AD can reach the Player in time, the data will generate a continuous playback period for that layer.

When considering layer dependency, the following embodiment applies to networks that may not guarantee sufficient throughput to insure timely delivery of all layers for uninterrupted playback at the client. All ADs of higher layers are embedded within ADs of lower layers. The Server, when under network throughput constraint, will prefer to stretch the ADs of lower layers as much as possible rather than creating short embedded ADs of higher layers. Starting and terminating layers is perceptible during playback, thus it is not optimal to frequently change the number of layers being transmitted. In practice, the values of various algorithmic parameters should be based on considerations of user playback experience under typical network statistical conditions. For example, rapid jumps from five to one enhancement layers are more annoying than gradual “terracing” of the enhancement layers over time. Hence the choice of parametric values should be chosen carefully to maximize the quality of the end user's acoustic experience.

Also, the Server will always maintain in-order delivery of frames and sub-frames, such that frames with lower IDs will always be delivered to the application before frames with higher IDs. Similarly, within a frame, sub-frames with lower IDs are always delivered before sub-frames with higher IDs. This can be guaranteed by using a network protocol such as TCP or an application level protocol used in conjunction with a network protocol such as UDP.

The method of the present disclosure is now illustrated through the use of a set of equations. The applicable notation is defined as follows:

L: index of layer

N: index of upper-most (highest) enhancement layer

Nⱼ^{L}: id for the sub-frame in frame j from layer L

Fⱼ: total data in frame j

ΔFⱼ^{(L)}: the number of bytes of data in frame j for layer L

jₛ^{(i,L)}: the lowest frame index of an active duration of layer L, and is carried by packet i (Note that a single data packet may contain sub-frames from multiple frames)

jₑ^{(i,L)}: the highest frame index of an active duration of layer L, and is carried by packet i

Δd_{L}(i): the number of bytes of payload of packet i that is allocated to layer L

K(i): the total payload size of packet i

Δt(i): the interval between the departure time of packet i and i+1

ΔT(i): the interval between the arriving time of packet i and i+1

Δn_{1L}: base layer offset between layer 1 and L

α_{L}: buffering factor for layer L

ƒ(x): a function that converts from accumulated packet departure time to accumulated packet arriving time

b_{L}(j): buffered playback time at the Player for layer L after packet j arrives

Kₘₜᵤ: maximum transfer unit (or maximum packet payload)

ΔK_{L-1}(m): remaining payload space (bytes) in packet m after layers 1 to L−1 have been allocated

r_{L}(t): the failure rate of layer L for frames missing their playback deadline at time t

T_{b}: Amount of time spent by the playback device buffering packets before beginning playout.

h_{L}(d): a function that calculates the corresponding playback time of a portion of packet payload of size d from layer L

tdⱼ: the departure time of packet j from the sender

taⱼ: the arriving time of packet j at the receiver

Next, a base layer offset between frames can be defined. Assume an AD of layer L starts with packet i. Thus,

jₛ^{(i,L)}=jₛ^{(i-Δn}^{_{1L}}^{,1)}

That is, the first frame index of layer L in packet i is the same as the first frame index for the base layer (L=1) in packet i−Δn_{1L}. Δn_{1L} is referred to as the base layer offset between layer 1 and L. FIG. 2 shows an example of base layer offset. In the figure, packet 3 contains a sub-frame from frame 0, layer 3, N₀³. Packet 0 contains the sub-frame from frame 0, layer 1, N₀¹, the base layer for frame 0. Thus, the base layer offset is 3 packets.

Since in one embodiment, layer L depends upon layer L−1 for decoding, the AD of layer L must be embedded in the AD of layer L−1.

Assume the first AD of layer L starts with frame j in the k_{L}th packet, and this AD continues up to the m−1st packet. Assume also that the payload for the layer L portion in the k_{L}th packet represents the same frame number(s) as the base layer frame(s) that are carried in the k_{L}−Δn_{1L}th packet. Thus, at the playback device, layer L in the k_{L}th packet must be played back at the same time as the base layer in the k_{L}−Δn_{1L}th packet since they include data from the same frame(s).

When Δn_{1L}>0, the Server is sending a frame for layer L that precedes the base layer frame in the current packet. When Δn_{1L}=0, the layer L and the base layer frames are synchronized and are contained in the same packet. We refer to Δn_{1L} as the base layer offset between layer L and the base layer for this particular AD.

A playback time conversion function can be defined which correlates a quantity of compressed data to the playback time required for the data. Assume d to be a certain amount of compressed data. A function h(d) can be defined that calculates the playback time that corresponds to d. Multiple instances of h(d) that correspond to the constituent layers are denoted as h_{L}(d), where L=1, . . . , N and where N is the number of layers.

An arrival time mapping function may also be defined. Assume ΔT(i) is the interval between the arriving times of the ith and i+1st packets at the Player, and also that

$${\sum }_{i = j}^{k} Δ T ( i ) = f ( {\sum }_{i = j}^{k} Δ t ( i ) )$$

where packets j to k are sent consecutively by the Server, and ƒ(x) is a function that depends on network conditions and transport protocol behavior.

The Player normally buffers a certain amount of data before starting the decoding process. Assuming the Player pre-buffer time is T_{b}, and within T_{b} there are l packets that arrive in the Player, the Player pre-buffer time can be expressed as

$${T}_{b} \geq {\sum }_{i = 1}^{l - 1} Δ T ( i ) .$$

Packets 1 to l can be referred to as, pre-buffered packets.

Again, a packet may contain multiple consecutive subframes for a single layer. Thus, the number of bytes for layer L within packet i may be calculated according to:

$$Δ {d}_{L} ( i ) = {\sum }_{j = {j}_{s}^{( i , L )}}^{{j}_{e}^{( i , L )}} Δ {F}_{j}^{( L )} \qquad ( 1 )$$

The total payload of the packet is the sum of the bytes for each of the layers in the packet:

$$K ( i ) = {\sum }_{L = 1}^{N} Δ {d}_{L} ( i ) \qquad ( 2 )$$

FIG. 3 illustrates the meaning of the above equations, wherein packet I contains nine subframes from three original frames, subframes 8-10, and three layers, layers 1-3. The total payload is K(i).

A base layer payload constraint is calculated as follows. Assume the Server has sent packets j to m−1, and is now preparing the payload of packet m. In the mth packet, the payload portion for the base layer is conditioned by:

$${b}_{1} ( j ) + {h}_{1} ( {\sum }_{i = j + 1}^{m} Δ {d}_{1} ( i ) ) \geq f ( {\sum }_{i = j}^{m} Δ t ( i ) ) + {α}_{1} \qquad ( 3 )$$

where b₁(j) is buffered playback time when the jth packet arrives at the receiver. In the presently disclosed method, this information is to be returned to the Server as feedback for characterizing the end-to-end network conditions. α₁ is a buffering factor introduced to compensate for the statistical uncertainty of an end-to-end path. In essence, this equation states that given the current amount of buffered data at the receiver, and current network conditions, the base layer must arrive in time to be played back at the playback device.

Consideration is now given to enhancement layer payload calculation constraints. Let Kₘₜᵤ represent the maximum packet payload size determined by the network protocol. After allocation of Δdᵢ(m) for layers i=1, . . . , L−1 for the mth packet, the remaining payload space available for the Lth layer is

$$Δ {K}_{L - 1} ( m ) = {K}_{mtu} - {\sum }_{i = 1}^{L - 1} Δ {d}_{i} ( m ) \qquad ( 4 )$$

The payload arrival time constraint for layer L is now considered for the case where L is in an AD period, and then the case where L is not in an AD period.

Assume layer L is in an AD period (which implies that all layers from 1 to L−1 are also in their corresponding AD periods), and the Server has sent packets j to m−1. For the construction of the mth packet, the portion of the payload for layer L should be conditioned by:

$${b}_{L} ( j ) + {h}_{L} ( {\sum }_{i = j + 1}^{m} Δ {d}_{L} ( i ) ) \geq f ( {\sum }_{i = j}^{m} Δ t ( i ) ) + {α}_{L} \qquad ( 5 )$$

Alternatively, assume the mth packet starts a new AD period for layer L, and the first frame index of layer L in this packet is the same as the first frame index of the base layer in the m−Δn_{1L}th packet. Δn_{1L} is the base layer offset between layer L and 1 as defined previously. The maximum base layer offset Δn_{1L} is constrained by:

$${b}_{1} ( j ) + {h}_{1} ( {\sum }_{i = j + 1}^{m - Δ {n}_{1 L}} Δ d ( i ) ) \geq f ( {\sum }_{i = j}^{m - Δ {n}_{1 L} - 1} Δ t ( i ) ) + f ( {\sum }_{i = m - Δ {n}_{1 L}}^{m - 1} Δ t ( i ) ) + {α}_{1} \qquad ( 6 )$$

This equation says that if a subframe from layer L is in packet m, then it must be able to arrive at the playback device so that it can be played back at the same time as its base layer which is in packet m−Δn_{1L}. Again, the base layer offset dictates that it is possible for subframes from the same frame to be allocated to different network packets.

The above algorithms are based on an arrival time mapping function, ƒ(x), i.e. it is based on an estimate of the time for a packet to travel from the server to the playback device over the network. Correlated with network conditions and transport protocol behavior, it is time-varying and random. ƒ(x) can be calculated by several methods, using various network and client feedback mechanisms, as those skilled in the art would acknowledge. For example, one method used to calculate ƒ(x) is to create a set of timestamp pairs. A timestamp pair is the departure time from the server and the arrival time at the client for certain packets. The arrival time can be sent back from the client to the server using a predetermined protocol. ƒ(x) can then be calculated based on these timestamp pairs.

After allocating data for the uppermost layer N under the above constraints, there may still be available payload space. The available space in packet m can be calculated as follows.

$$Δ {K}_{N} ( m ) = {K}_{mtu} - {\sum }_{i = 1}^{N} Δ {d}_{i} ( m ) > 0 \qquad ( 7 )$$

This remaining available payload space may be used for a variety of purposes. In one embodiment, the payload space is used to compensate the layer having the lowest frame index of its last sent subframe.

For example, assume that layers 1 to L are in AD and the last frame sent from layer L is j (mL) after the mth packet is sent. The algorithm for allocating the leftover space is as follows:

### Algorithm I

1. Pick the layer L having the smallest jₑ^{(m,L)} and layer number;
2. If the left over space is larger than or equal to the size of the sub-frame from layer L of the jₑ^{(m,L)}+1^{st} frame, include this sub-frame into the mth packet payload, and reduce the leftover space by the size of this sub-frame—repeat step 1.;
3. Otherwise, stop.

The buffering factors, α_{L}, where L=1 to N, are parameters intended to compensate for network throughput fluctuation. Large buffering factors may cause the system to be more conservative, whereby less ADs from higher numbered layers (i.e. lower priority layers) are delivered.

In one exemplary implementation, these buffering factors can be adapted based upon the failure rate of frames meeting the respective playback deadlines. Thus, when the failure rates are high, the buffering factor values are increased. Algorithm II shows a possible method for adapting α_{L} based on the failure rate.

### Algorithm II

1. Assume the Player sends feedback to the Server continuously at the time when packets j₁, j₂, j₃, . . . arrive and r_{L}(jᵢ) is the failure rate of frames that can not meet the respective playback deadlines. r_{L}(jᵢ) can be sent back to the Server as feedback after the arrival of jᵢ, or inferred by the server based on other feedback parameters.
2. If r_{L}(jᵢ)>r_{threshold}, adjust α_{L}(jᵢ)=α_{L}(jᵢ₋₁)/ρ, and if α_{L}(jᵢ)>αₘₐₓ, adjust α_{L}(jᵢ)=αₘₐₓ;
3. Otherwise, adjust α_{L}(jᵢ)=α_{L}(jᵢ₋₁)ρ, and if α_{L}(jᵢ)<αₘᵢₙ, adjust α_{L}(jᵢ)=αₘᵢₙ.
   In the Algorithm II, assume 0<ρ<1, where ρ is a tuneable parameter.

Given the foregoing, the server's payload allocation method comprises the following steps:
1. Initialize α_{L}, for L=1, . . . , N, and j=1;
2. For packet j, combine equations (1), (2) and (3) to conduct payload allocation for the base layer, layer 1;
3. Use equation (4) to calculate the remaining payload space in packet j;
4. For packet j, combine equations (5) and (6) to conduct payload allocation of the enhancement layers, layers 2 to N, recognizing that some of the layers may have zero allocation if the payload space runs out;
5. Use equation (7) to calculate the remaining payload space in packet j after the minimum payload requirements of all layers are satisfied;
6. Use Algorithm I to conduct payload allocation of the remaining space;
7. Update function ƒ(x) based on current network and application characteristics.
8. Use algorithm I to adjust α_{L}; and
9. Adjust j=j+1 and repeat step 2.

As stated above, one method to calculate ƒ(x), is to create a set of timestamp pairs, where a pair [tdᵢ,taᵢ] is defined to be the departure time of a packet i from the server and its associated arrival time at the playback device. Arrival time measurements can be sent back to the Server as feedback, using any well-known feedback mechanism. In addition to calculating ƒ(x), the presently disclosed invention uses timestamp pairs to estimate the buffer status at the Player, and the failure rate for frames not received by the established deadline.

The timestamp data pairs can be used to estimate the buffer capacity status of layers that are in active duration at the time of taᵢ. Using layer L as an example, assume that the Server knows layer L is in Active Duration (AD) at time taⱼ where j<i. The Server also knows up to tdⱼ that the last sub-frame sent from this layer is Nⱼ^{L}. Assume the Server also knows that at time taⱼ at the Player, there are Bⱼ^{L} sub-frames from layer L buffered in the Player buffer such that the Player is decoding the frame of the base layer having sequence number Nⱼ^{L}−Bⱼ^{L} at the time taⱼ.

Assume when the Server sends packet i it records the last sub-frame sequence number for all layers it has sent to that point. For example, for layer L, assume the sequence number is Nᵢ^{L}. Also assume the playback time of each coding block is Δt. When the timestamp taᵢ is sent back to the Server by the Player, the Server estimates the buffered sub-frames of layer L at time taᵢ according to:

Bᵢ^{L}=Nᵢ^{L}−Nⱼ^{L}+Bⱼ^{L}−[(taᵢ−taⱼ)/Δt]

The estimation is then used by the payload allocation algorithm discussed above.

A frame failure rate is defined as the percentage of frames that missed the respective decoding deadline. For the period [taⱼ,taᵢ], the number of frames that fail to make it to the Player on time is calculated as −Bᵢ^{L}. If Bᵢ^{L}>0, it means the frame failure rate for layer L is zero. Otherwise, the failure rate for layer L is estimated as:

$${Γ}_{i}^{L} = \frac{- {B}_{i}^{L}}{( {ta}_{i} - {ta}_{j} ) / Δ t}$$

This estimation can be used by the payload allocation algorithm discussed above.

The Server architecture of the present system may be implemented as a stand-alone module such as a plug-in module or library file for other systems. Certain requirements for implementing the system include the ability to: support a multitasking or multithreading programming model or a combination of the two; support streaming-related protocol services such as Real Time Streaming Protocol (RTSP) to the module; provide communication services to the module via Operating System (OS) socket Application Programming Interfaces (APIs); and support for MPEG-4 or similar file formats, in which media tracks are available for conveying coding-related data.

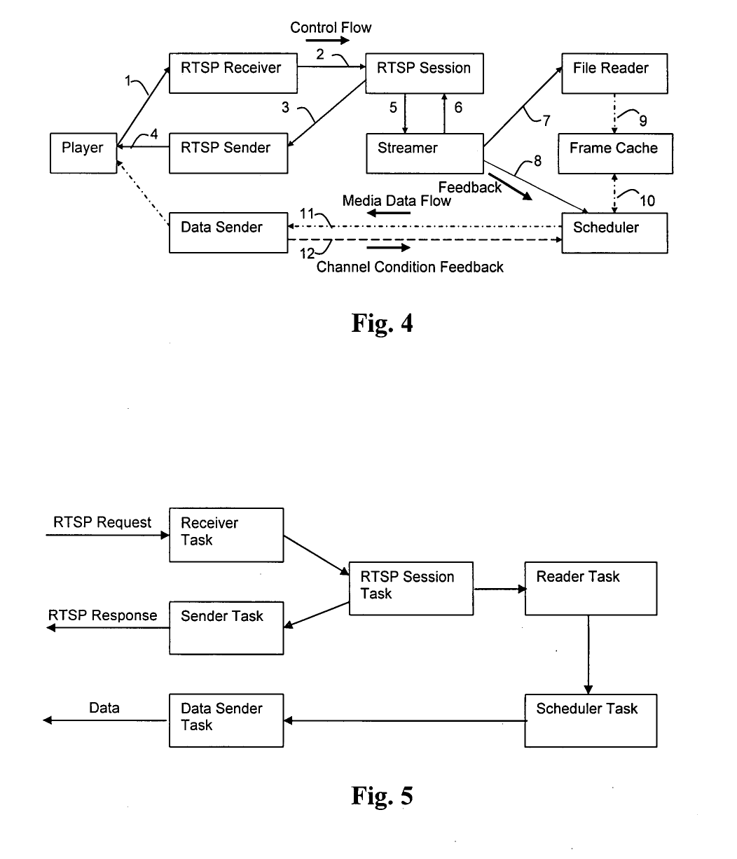

FIG. 4 provides a block diagram of the functional blocks preferred for implementing dynamic streaming according to the presently disclosed invention, along with the data flows among those blocks. Eight functional blocks (ignoring for the time-being the Player) and twelve interfaces, or data exchange paths, are illustrated. Each block is preferably implemented as a class in an object-oriented language such as C++. A variety of well-known computing platforms can be adapted for use in supporting these functions. The blocks and paths are addressed in the following description.

The RTSP Receiver is responsible for receiving and parsing RTSP requests from the Player. The requests are received directly through a communication socket API provided by the OS. Once parsed, the requests are converted into a standard data structure for subsequent processing.

The RTSP Session block is responsible for handling standard RTSP requests pertaining to an RTSP streaming session. The requests may include a command selected from among: DESCRIBE; SETUP; PLAY; PAUSE; TEARDOWN; PING; SET_PARAMETER; and GET_PARAMETER. RTSP Session is also responsible for maintaining status parameters associated with each session. The RTSP Session functional block exchanges with the Streamer functional block to execute the streaming control actions requested through the received RTSP requests. Streamer, discussed subsequently, provides APIs for RTSP Session to execute the requested commands.

The RTSP Sender sends RTSP responses, created by the RTSP Session via the Streamer socket API, to the Player.

The File Reader has two primary functions. First, it must open, load, and create frame and sub-frame indexing information necessary for locating each individual data unit within a source file. Second, the File Reader must provide an API for enabling frame or sub-frame units of data to be read, and to facilitate file seek operations.

The Frame Cache functional block is a temporary work place for packet assembly. This function is guided by adaptation algorithms implemented by the Scheduler. The required functions of the Frame Cache include enabling centralized cache entry management including cache entry recycling, providing free cache buffer space for the File Reader, accommodating frame indexing, allowing random access to individual frames and sub-frames, enabling relatively low cache operation overhead, and providing APIs to the Scheduler for cache frame access.

The Scheduler is the intelligent component that implements novel algorithms to carry out packet generation and delivery. Required functions include the generation of packets according to a prescribed algorithm, the processing of feedback received from the Player, and maintaining a parameter that controls the temporal interval between instances of packet departure. The latter parameter is adaptively adjusted by the Data Sender.

The Data Sender is primarily responsible for writing packets to the network socket and for performing throughput estimation. The latter enables the Data Sender to adaptively control the time interval by which the Scheduler is invoked for new packet generation.

Twelve data flows, also referred to as interfaces, are illustrated in FIG. 4. Each is briefly characterized in the following.

1—The RTSP Receiver only receives standard RTSP requests, thus minimizing system complexity.

2—The RTSP Session functional block provides an API for the RTSP Receiver to submit RTSP requests received from the Player.

3—The RTSP Sender provides an API for the RTSP Session to submit RTSP response messages it has created back to the Player.

4—Responses sent by the RTSP Sender must conform to the RTSP standard format.

5—The Streamer provides an API to the RTSP Session for processing RTSP requests issued by the Player. The request types to be processed by the Streamer include: DESCRIBE; SETUP; PLAY; PAUSE; TEARDOWN; and SET_PARAMETER.

6—The RTSP Session provides an API for the Streamer to signal session-related events, which may include: reach the end of a media track; or a PAUSE point set by a PAUSE command has been reached.

7—The File Reader provides an API to the Streamer to enable the following control: start or stop the File Reader; and adjust the speed by which the File Reader reads frames from the encoded multimedia files.

8—The Scheduler provides an API to the Streamer in order to process feedback received from the playback devices, for example, timestamp measurements for received packets.

9—The Frame Cache provides an API for the File Reader to store encoded frames.

10—The Frame Cache provides an API to the Scheduler to selectively fetch frames or sub-frames for packet payload construction and to allow the Scheduler to flash frames from the cache that are deemed obsolete by the payload allocation algorithm.

11—The Data Sender provides an API for the Scheduler to submit packets to be sent out to the Player.

12—The Scheduler provides an API for the Data Sender to adjust the parameter used to control the inter-departure time for packets.

The functional blocks depicted in FIG. 4 can be executed by six parallel tasks. The invoking relationship among the tasks is as depicted in FIG. 5.

The Scheduler algorithms themselves have been previously explained. However, at this point, certain configurable parameters implemented by the Scheduler are defined.

Throughput Estimation Interval—The Scheduler algorithm needs to calculate ƒ(x), the estimated time for a packet to travel from the server to the playback device. To conduct an estimation at the server, the server expects feedback information from the network or playback device. This parameter specifies the frequency of the measurements used to calculate ƒ(x). For example, this parameter can be set to five, i.e. the network or playback device returns a measurement for every five frames that are sent.

Buffer Initialization Duration—Through a standard protocol, for example SDP, the Server can make a recommendation to the Player of the required number of seconds of media to be accumulated before the decoder starts decoding. This parameter is tightly related to network characteristics, particularly bandwidth fluctuation and end-to-end delay jitter. In one embodiment, this parameter is set to ten seconds.

Estimated Throughput—This parameter represents an initial value of the Player perceived throughput estimation relative to the compressed media bit rate. When the Maximum Stream Bit Rate parameter (discussed below) is higher than the compression bit rate, the value of the present parameter should be set to 1.0.

Base Layer Priority Ratio—This parameter is designed to control the performance of the adaptation algorithm executed by the Scheduler. The larger the value, the more conservative the adaptation, in the sense that the algorithm will attempt to schedule more data from the base layer to be delivered first. The configured value is only valid at the initial execution of the algorithm; the value will be adjusted to a different value automatically based upon feedback from the Player. The default value in one embodiment is one.

Maximum Stream Bit Rate—This parameter defines the maximum end-to-end bit rate that can be achieved between the Server and Player, and in certain implementations may be determined by a network or streaming service administrator. In one embodiment, this number is set to forty kilobits per second.

The rate of packet generation is controlled by a packet departure interval parameter. This parameter is maintained by the Scheduler but can be adjusted by the Data Sender. An algorithm for deploying this parameter starts with the assumption that the Data Sender must maintain the packet queue for a data socket through which the packets are sent out to the network and on to the Player.

When a packet is submitted to the Data Sender, the Data Sender checks the packet queue length. If the packet queue length is less than a predetermined threshold, but not zero, the Data Sender makes no change to the packet generation interval. If the queue length is above the predetermined threshold but below a second threshold, the Data Sender reduces the interval parameter by a multiplying factor, which may be referred to as a slow-down factor, conveyed to the Scheduler. If the queue length is above the second predetermined threshold, the interval parameter is set to a maximum value, whereby the Scheduler becomes idle. In one embodiment, the second threshold is defined as three times the first threshold. If on the other hand the Data Sender detects a zero-length queue, the interval parameter is reset to an initial value.

These and other examples of the invention illustrated above are intended by way of example and the actual scope of the invention is to be limited solely by the scope and spirit of the following claims.

What is claimed is:

1. A system for dynamically streaming scalable media content between a server and a playback device, the media being comprised of temporally sequential data packets, each packet being comprised of temporally sequential frames and each frame being comprised of layers including a base layer and plural enhancement layers, the system comprising:
a player interface for exchanging streaming commands and responses with the player;
a file reader for accessing a media file and for associating frame and sub-frame indexing information with the media file;
a feedback processor for receiving feedback from the playback device and for estimating network throughput between the server and the playback device on the basis of the feedback;
a scheduler for receiving the estimated network throughput from the feedback processor, for determining, according to a predefined algorithm, the media file content of successive packets, and for scheduling the temporal interval between instances of packet departure to the playback device; and
a data sender for writing packets to a network socket for delivery to the playback device.

2. The system of claim 1, wherein the feedback processor and the data sender are realized as a single module.

3. The system of claim 1, wherein the feedback received by the feedback processor is characteristic of the number of packets queued in a playback device receive buffer.
